(19) United States
(12) Patent Application Publication
(10) Pub. No.: US 2026/0273573 A1
(43) Pub. Date: Sep. 17, 2026

(54) Paint Roller Pole Device

(71) Applicant: Dale Bost, Vallejo, CA (US)

(72) Inventor: Dale Bost, Vallejo, CA (US)

(21) Appl. No.: 19/076,005

(22) Filed: Mar. 11, 2025

(51) Int. Cl. B05C 17/02

(52) U.S. Cl. CPC B05C 17/0245; B05C 17/0205

(57) ABSTRACT

A paint roller pole device includes a pole which can be extended upwardly along a paintable surface. A threaded coupler is attached to the pole and a pin well extends laterally into the threaded coupler. A paint roller is included which has a handle that is releasably matable to the threaded coupler on the pole. Furthermore, the paint roller can be rolled upwardly and downwardly along the paintable surface when the user extends the pole along the paintable surface. A pin is extendable through the handle of the paint roller and into the threaded coupler when the paint roller is releasably mated to the threaded coupler. The pin inhibits the handle of the paint roller from accidentally uncoupling from the threaded coupler to enable the user to employ the paint roller to apply paint to the paintable surface without having the paint roller becoming uncoupled from the pole.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) Incorporation-by-reference of Material Submitted on a COMPACT DISC OR AS A TEXT FILE VIA THE OFFICE ELECTRONIC FILING SYSTEM

Not Applicable

### (f) Statement Regarding Prior Disclosures by the Inventor or JOINT INVENTOR

Not Applicable

### (g) BACKGROUND OF THE INVENTION

### (1) Field of the Invention

The disclosure relates to paint roller devices and more particularly pertains to a new paint roller device for inhibiting a paint roller from accidentally becoming uncoupled from a pole. The device includes a pole and a threaded coupler attached to the pole and a pin well extending laterally into the threaded coupler. The device includes a paint roller which has a handle that is threadably matable to the threaded coupler. The device includes a pin which is extendable through an aperture in the handle and into the pin well to inhibit the handle from accidentally unthreading from the threaded coupler.

### (2) Description of Related Art Including Information Disclosed Under 37 CFR 1.97 and 1.98

The prior art relates to paint roller devices including: an extension pole for paint roller which has a threaded coupler for threadably engaging a handle of a paint roller; an extension handle for a paint roller which has a locking mechanism integrated into an extension handle which that is retractable into the extension handle or extended outwardly from the extension handle; a paint roller device that has a handle which is adapted to releasably mate to a variety of extension poles; an extension pole adapter which includes a cylindrical housing that receives an extension pole and a threaded coupler integrated into the cylindrical housing for attaching the threaded coupler to the extension pole; a locking mechanism for a handle which includes an adapter that has circumferentially spaced thread segments which are axially insertable into a tool handle socket. In no instance does the prior art disclose a paint roller pole device that includes a handle and a threaded coupler attached to the pole which has a pin well extending into the threaded coupler and a paint roller which has a handle that is threadably matable to the threaded coupler and a pin that is extendable through an aperture in the handle and into the pin will to inhibit the handle of the paint roller from accidentally unthreading from the threaded coupler.

### (h) BRIEF SUMMARY OF THE INVENTION

An embodiment of the disclosure meets the needs presented above by generally comprising a pole which can be extended upwardly along a paintable surface. A threaded coupler is attached to the pole and a pin well extends laterally into the threaded coupler. A paint roller is included which has a handle that is releasably matable to the threaded coupler on the pole. Furthermore, the paint roller can be rolled upwardly and downwardly along the paintable surface when the user extends the pole along the paintable surface. A pin is extendable through the handle of the paint roller and into the threaded coupler when the paint roller is releasably mated to the threaded coupler. The pin inhibits the handle of the paint roller from accidentally uncoupling from the threaded coupler to enable the user to employ the paint roller to apply paint to the paintable surface without having the paint roller becoming uncoupled from the pole.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a paint roller pole device according to an embodiment of the disclosure.

FIG. 2 is an exploded perspective view of an embodiment of the disclosure.

FIG. 3 is a perspective view of an embodiment of the disclosure showing a handle of a paint roller being threadably coupled to a threaded coupler on a pole.

FIG. 4 is a front view of an embodiment of the disclosure.

FIG. 5 is a cross sectional view taken along line 5-5 of FIG. 4 of an embodiment of the disclosure.

FIG. 6 is a perspective in-use view of an embodiment of the disclosure.

### (j) DETAILED DESCRIPTION OF THE INVENTION

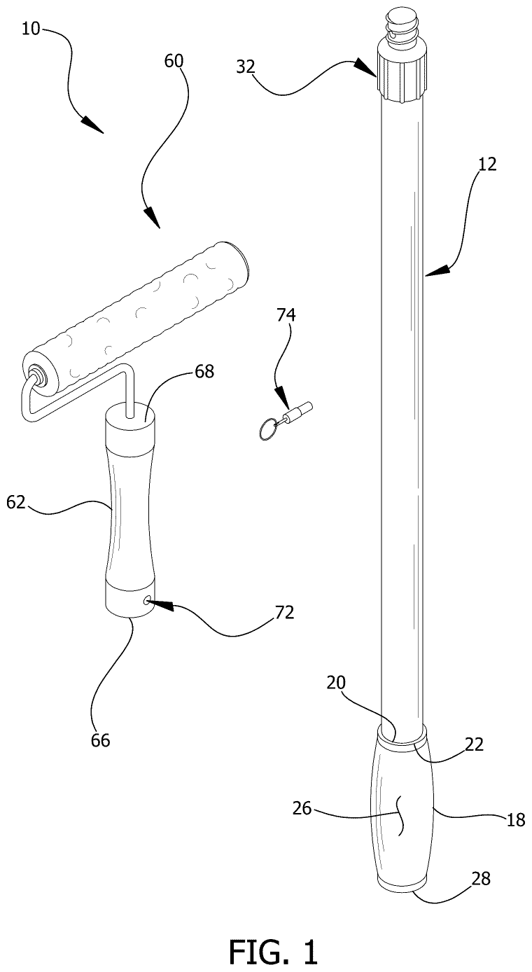

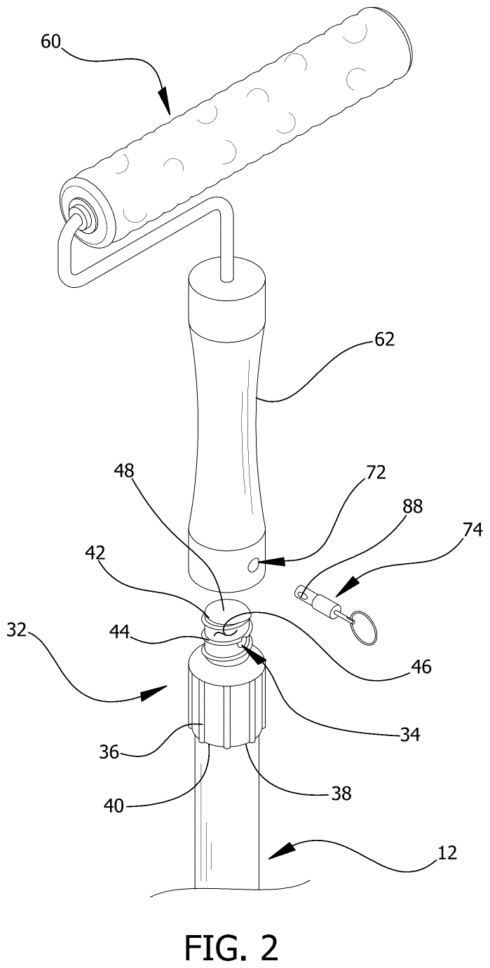

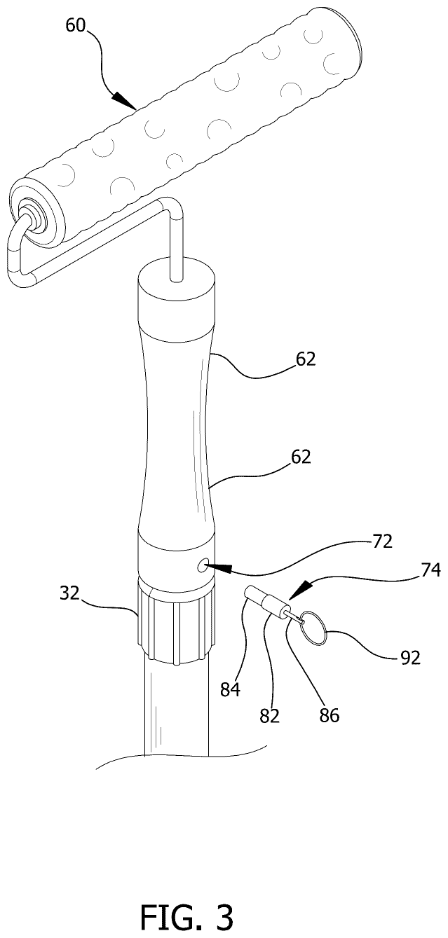

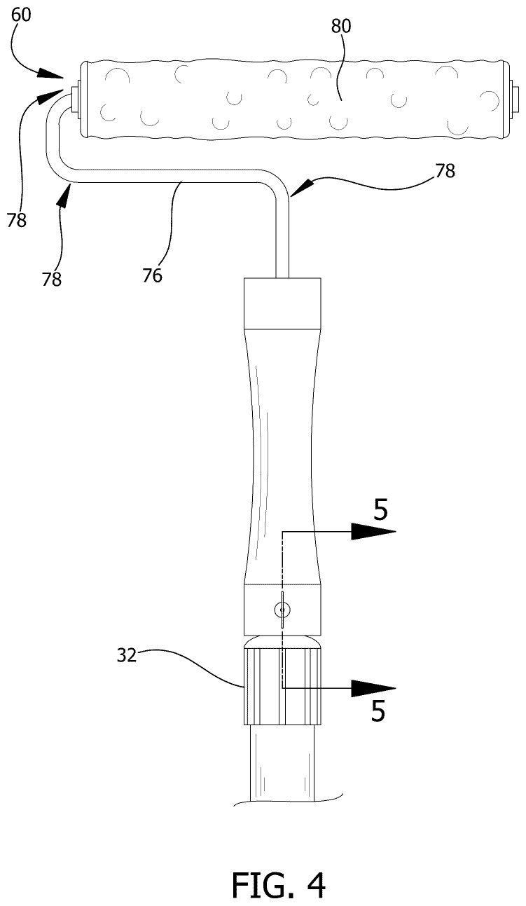

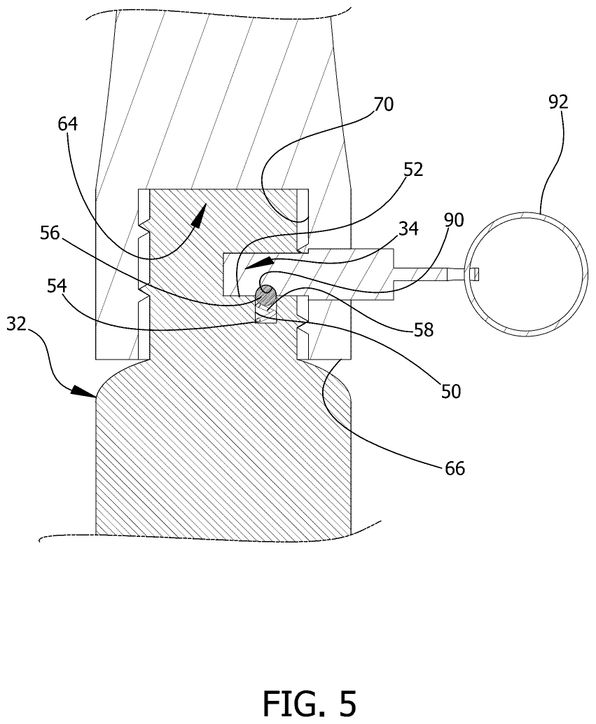

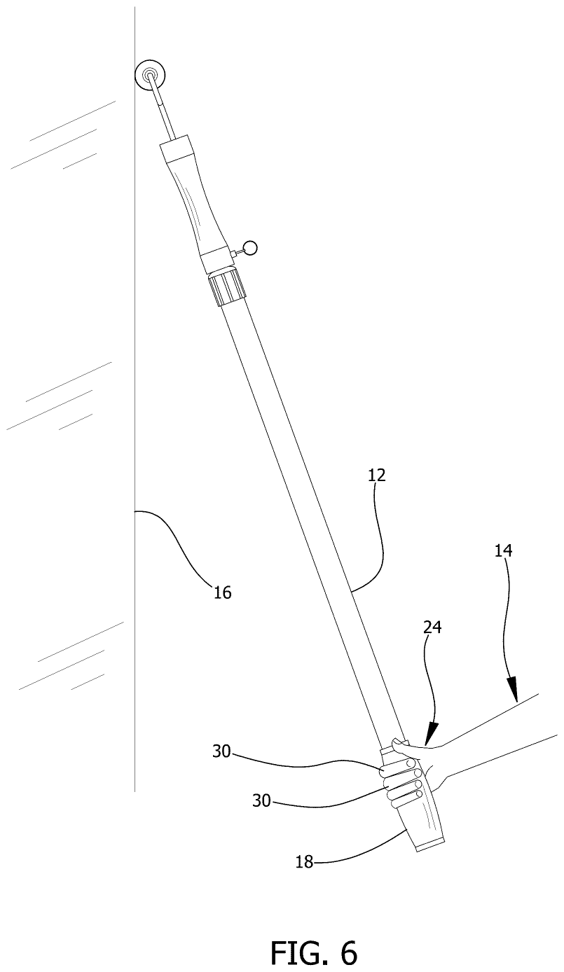

With reference now to the drawings, and in particular to FIGS. 1 through 6 thereof, a new paint roller device embodying the principles and concepts of an embodiment of the disclosure and generally designated by the reference numeral 10 will be described.

As best illustrated in FIGS. 1 through 6, the paint roller pole device 10 generally comprises a pole 12 which is elongated to enable a user 14 to extend the pole 12 upwardly along a paintable surface 16. The paintable surface 16 may be a wall of a room or a floor of a room, for example, or any other type of surface that is commonly painted. A grip 18 is attached to the pole 12 and the grip 18 can be gripped by the user 14 to enhance the user's 14 ability to maintain their grip on the pole 12. The grip 18 has an upper end 20 which is attached to a bottom end 22 of the pole 12 such that the grip 18 can be gripped by one of the user's hands 24 such that the other of the user's hands 24 can be employed for gripping the pole 12 at a point that is spaced from the grip 18. Furthermore, the grip 18 has an outer surface 26 which extends between the upper end 20 of the grip 18 and a lower end 28 of the grip 18; the outer surface 26 is continuously arcuate about an axis extending between the upper end 20 and the lower end 28 such that the grip 18 has a cylindrical shape to enable the user 14 to wrap their fingers 30 around the outer surface 26. Additionally, the outer surface 26 curves outwardly between the upper end 20 and the lower end 28 to inhibit the user's fingers 30 from sliding along the outer surface 26 when the user's fingers 30 are wrapped around the outer surface 26. The grip 18 may be comprised of a resiliently compressible material, including but not being limited to rubber or silicone, to enhance comfort for the user 14 while the user 14 is gripping the grip 18.

A threaded coupler 32 is attached to the pole 12 and the threaded coupler 32 is distally positioned with respect to the grip 18. Furthermore, the threaded coupler 32 can be distally located with respect to the user 14 when the user 14 extends the pole 12 upwardly along the paintable surface 16. The threaded coupler 32 has a pin well 34 extending laterally into the threaded coupler 32 and the threaded coupler 32 has a lower portion 36 which has a lower end 38 that is coupled to a top end 40 of the pole 12. The threaded coupler 32 has an upper portion 42 extending upwardly from the lower portion 36 and the upper portion 42 has a diameter that is less than a diameter of the lower portion 36. Additionally, the upper portion 42 has threads 44 integrated into an outside surface 46 of the upper portion 42 and the threads 44 extend between the lower portion 36 and an upper end 48 of the upper portion 42.

The pin well 34 extends laterally into the upper portion 42 and the pin well 34 is positioned between the lower portion 36 and the upper end 48 of the upper portion 42. The upper portion 42 has a lock well 50 which extends downwardly from a bounding surface 52 of the pin well 34 toward the lower portion 36 of the threaded coupler 32. Additionally, the lock well 50 is centrally located along the pin well 34. A biasing member 54 is positioned within the lock well 50 and a ball 56 is attached to a top end 58 of the biasing member 54 such that the ball 56 extends partially into the pin well 34.

A paint roller 60 is included which has a handle 62 that is releasably matable to the threaded coupler 32 on the pole 12. Furthermore, the paint roller 60 can be rolled upwardly and downwardly along the paintable surface 16 when the user 14 extends the pole 12 along the paintable surface 16. The handle 62 has a threaded coupler well 64 extending into a lower end 66 of the handle 62 toward an upper end 68 of the handle 62 and the threaded coupler well 64 has a bounding surface 70 which is threaded. The threaded coupler well 64 insertably receives the upper portion 42 of the threaded coupler 32 having the bounding surface 70 threadably engaging the threads 44 on the outside surface 46 of the upper portion 42 of the threaded coupler 32. The handle 62 has an aperture 72 extending through the handle 62 and into the threaded coupler well 64. The aperture 72 is aligned with the pin well 34 in the upper portion 42 of the threaded coupler 32 when the paint roller 60 is mated to the upper portion 42 of the threaded coupler 32. Additionally, the handle 62 is concavely arcuate between the upper end 68 and the lower end 66 to inhibit the user's fingers 30 from sliding along the handle 62 when the user 14 grips the handle 62 to employ the paint roller 60 without the pole 12 for painting.

A pin 74 is extendable through the handle 62 of the paint roller 60 and into the threaded coupler 32 when the paint roller 60 is releasably mated to the threaded coupler 32. The pin 74 inhibits the handle 62 of the paint roller 60 from being accidentally uncoupled from the threaded coupler 32. Furthermore, the pin 74 enables the user 14 to employ the paint roller 60 to apply paint to the paintable surface 16 without having the paint roller 60 becoming uncoupled from the pole 12. The paint roller 60 includes an arm 76 which extends upwardly from the handle 62 that has a series of bends 78 and a roller 80 which is rotatably applied to arm 76 such that the roller 80 is perpendicular to the handle 62.

The pin 74 has a medial section 82 extending between each of a front section 84 and a rear section 86. The medial section 82 has a diameter which is greater than a diameter of either of the front section 84 or the rear section 86. Additionally, the diameter of the front section 84 is greater than the diameter of the rear section 86. The pin 74 has a ball well 88 extending into the front section 84 which extends along a line that is oriented perpendicular to a lengthwise axis of the pin 74. The front section 84 is extendable through the aperture 72 in the handle 62 and into the pin well 34 in the upper portion 42 of the threaded coupler 32 when the handle 62 is releasably mated to the upper portion 42 having a threshold between the front section 84 and the medial section 82 abutting an outside surface of the handle 62.

The ball well 88 is aligned with the lock well 50 in the upper portion 42 of the threaded coupler 32 when the pin 74 is seated into the pin well 34 thereby enabling the ball 56 to be biased to extend into the ball well 88 for releasably retaining the pin 74 in the pin well 34. The ball well 88 has a bounding surface 90 which is concavely arcuate with respect to the front section 84 thereby enabling the bounding surface 90 of the ball well 88 to conform to the ball 56 when the ball 56 is biased into the ball well 88. The ball 56 is urged to travel downwardly into the lock well 50 when the pin 74 is pulled outwardly from the pin well 34 thereby enabling the pin 74 to be removed from the pin well 34. An annular ring 92 extends through the rear section 86 of the pin 74 to enable the user 14 to extend one of their fingers 90 through the annular ring 92 for removing the pin 74 from the pin well 34.

In use, the handle 62 of the paint roller 60 is threaded onto the threaded coupler 32 until the aperture 72 in the handle 62 is aligned with the pin well 34 in the threaded coupler 32. The pin 74 is inserted through the aperture 72 and into the pin well 34 until the ball 56 is biased into the ball well 88. The user 14 grips the grip 18 and the pole 12 to enable the paint roller 60 to be rolled along the paintable surface 16 to apply paint to the paintable surface 16. Furthermore, the pin 74 inhibits the handle 62 of the paint roller 60 from accidentally unthreading from the threaded coupler 32 while the user 14 is rolling the paint roller 60 along the paintable surface 16. The annular ring 90 is gripped to remove the pin 74 from the pin well 34 and the aperture 72 to enable the user 14 to unthread the handle 62 from the threaded coupler 32.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A paint roller pole device for inhibiting a paint roller from accidentally unscrewing from a pole, said device comprising:
a pole being elongated wherein said pole is configured to enable a user to extend said pole upwardly along a paintable surface;
a grip being attached to said pole wherein said grip is configured to be gripped by the user to enhance the user's ability to maintain their grip on said pole;
a threaded coupler being attached to said pole, said threaded coupler being distally positioned with respect to said grip wherein said threaded coupler is configured to be distally located with respect to the user when the user extends said pole upwardly along the paintable surface, said threaded coupler having a pin well extending laterally into said threaded coupler;
a paint roller having a handle being releasably matable to said threaded coupler on said pole wherein said paint roller is configured to be rolled upwardly and downwardly along the paintable surface when the user extends said pole along the paintable surface; and
a pin being extendable through said handle of said paint roller and into said threaded coupler when said paint roller is releasably mated to said threaded coupler thereby inhibiting said handle of said paint roller from being accidentally uncoupled from said threaded coupler wherein said pin is configured to enable the user to employ said paint roller to apply paint to the paintable surface without having said paint roller becoming uncoupled from said pole.

2. The paint roller pole device according to claim 1, wherein said grip has an upper end being attached to a bottom end of said pole wherein said grip is configured to be gripped by one of the user's hands such that the other of the user's hands can be employed for gripping said pole at a point that is spaced from said grip.

3. The paint roller pole device according to claim 2, wherein said grip has an outer surface which extends between said upper end of said grip and a lower end of said grip having said outer surface being continuously arcuate about an axis extending between said upper end and said lower end such that said grip has a cylindrical shape wherein said grip is configured to enable the user to wrap their fingers around said outer surface.

4. The paint roller pole device according to claim 3, wherein said outer surface curves outwardly between said upper end and said lower end wherein said outer surface is configured to inhibit the user's fingers from sliding along said outer surface when the user's fingers are wrapped around said outer surface.

5. The paint roller pole device according to claim 1, wherein:
said threaded coupler has a lower portion which has a lower end being coupled to a top end of said pole;
said threaded coupler has an upper portion extending upwardly from said lower portion;
said upper portion has a diameter being less than a diameter of said lower portion;
said upper portion has threads being integrated into an outside surface of said upper portion; and
said threads extend between said lower portion and an upper end of said upper portion.

6. The paint roller pole device according to claim 5, wherein:
said pin well extends laterally into said upper portion; and
said pin well is positioned between said lower portion and said upper end of said upper portion.

7. The paint roller pole device according to claim 5, wherein:
said handle of said paint roller has a threaded coupler well extending into a lower end of said handle toward an upper end of said handle;
said threaded coupler well has a bounding surface being threaded; and
said threaded coupler well insertably receives said upper portion of said threaded coupler having said bounding surface threadably engaging said threads on said outside surface of said upper portion of said threaded coupler.

8. The paint roller pole device according to claim 7, wherein:
said handle has an aperture extending through said handle and into said threaded coupler well; and
said aperture is aligned with said pin well in said upper portion of said threaded coupler when said paint roller is mated to said upper portion of said threaded coupler.

9. The paint roller pole device according to claim 8, wherein:
said pin has a medial section extending between each of a front section and a rear section;
said medial section has a diameter being greater than a diameter of either of said front section or said rear section; and
said diameter of said front section is greater than said diameter of said rear section;
said front section of said pin is extendable through said aperture in said handle and into said pin well in said upper portion of said threaded coupler when said handle is releasably mated to said upper portion having a threshold between said front section of said pin and said medial section of said pin abutting an outside surface of said handle.

10. The paint roller pole device according to claim 9, wherein:
said upper portion of said threaded coupler has a lock well which extends downwardly from a bounding surface of said pin well toward said lower portion of said threaded coupler; and
said lock well is centrally located along said pin well;
said paint roller pole device includes a biasing member being positioned within said lock well;
said paint roller pole device includes a ball being attached to a top end of said biasing member such that said ball extends partially into said pin well; and
said pin has a ball well extending into said front section of said pin which extends along a line being oriented perpendicular to a lengthwise axis of said pin.

11. The device according to claim 10, wherein said ball well is aligned with said lock well in said upper portion of said threaded coupler when said pin is seated into said pin well thereby enabling said ball to be biased to extend into said ball well for releasably retaining said pin in said pin well.

12. The paint roller pole device according to claim 11, wherein said ball well has a bounding surface being concavely arcuate with respect to said front section thereby enabling said bounding surface of said ball well to conform to said ball when said ball is biased into said ball well.

13. The paint roller pole device according to claim 10, wherein said ball is urged to travel downwardly into said lock well when said pin is pulled outwardly from said pin well thereby enabling said pin to be removed from said pin well.

14. The paint roller pole device according to claim 1, further comprising an annular ring extending through a rear section of said pin wherein said annular ring is configured to enable the user to extend one of their fingers through said annular ring for removing said pin from said pin well.

15. A paint roller pole device for inhibiting a paint roller from accidentally unscrewing from a pole, said device comprising:
a pole being elongated wherein said pole is configured to enable a user to extend said pole upwardly along a paintable surface;
a grip being attached to said pole wherein said grip is configured to be gripped by the user to enhance the user's ability to maintain their grip on said pole, said grip having an upper end being attached to a bottom end of said pole wherein said grip is configured to be gripped by one of the user's hands such that the other of the user's hands can be employed for gripping said pole at a point that is spaced from said grip, said grip having an outer surface which extends between said upper end of said grip and a lower end of said grip having said outer surface being continuously arcuate about an axis extending between said upper end and said lower end such that said grip has a cylindrical shape wherein said grip is configured to enable the user to wrap their fingers around said outer surface, said outer surface curving outwardly between said upper end and said lower end wherein said outer surface is configured to inhibit the user's fingers from sliding along said outer surface when the user's fingers are wrapped around said outer surface;
a threaded coupler being attached to said pole, said threaded coupler being distally positioned with respect to said grip wherein said threaded coupler is configured to be distally located with respect to the user when the user extends said pole upwardly along the paintable surface, said threaded coupler having a pin well extending laterally into said threaded coupler, said threaded coupler having a lower portion which has a lower end being coupled to a top end of said pole, said threaded coupler having an upper portion extending upwardly from said lower portion, said upper portion having a diameter being less than a diameter of said lower portion, said upper portion having threads being integrated into an outside surface of said upper portion, said threads extending between said lower portion and an upper end of said upper portion, said pin well extending laterally into said upper portion, said pin well being positioned between said lower portion and said upper end of said upper portion, said upper portion having a lock well which extends downwardly from a bounding surface of said pin well toward said lower portion of said threaded coupler, said lock well being centrally located along said pin well;
a biasing member being positioned within said lock well;
a ball being attached to a top end of said biasing member such that said ball extends partially into said pin well;
a paint roller having a handle being releasably matable to said threaded coupler on said pole wherein said paint roller is configured to be rolled upwardly and downwardly along the paintable surface when the user extends said pole along the paintable surface, said handle having a threaded coupler well extending into a lower end of said handle toward an upper end of said handle, said threaded coupler well having a bounding surface being threaded, said threaded coupler well insertably receiving said upper portion of said threaded coupler having said bounding surface threadably engaging said threads on said outside surface of said upper portion of said threaded coupler, said handle having an aperture extending through said handle and into said threaded coupler well, said aperture being aligned with said pin well in said upper portion of said threaded coupler when said paint roller is mated to said upper portion of said threaded coupler;
a pin being extendable through said handle of said paint roller and into said threaded coupler when said paint roller is releasably mated to said threaded coupler thereby inhibiting said handle of said paint roller from being accidentally uncoupled from said threaded coupler wherein said pin is configured to enable the user to employ said paint roller to apply paint to the paintable surface without having said paint roller becoming uncoupled from said pole, said pin having a medial section extending between each of a front section and a rear section, said medial section having a diameter being greater than a diameter of either of said front section or said rear section, said diameter of said front section being greater than said diameter of said rear section, said pin having a ball well extending into said front section which extends along a line being oriented perpendicular to a lengthwise axis of said pin, said front section being extendable through said aperture in said handle and into said pin well in said upper portion of said threaded coupler when said handle is releasably mated to said upper portion having a threshold between said front section and said medial section abutting an outside surface of said handle, said ball well being aligned with said lock well in said upper portion of said threaded coupler when said pin is seated into said pin well thereby enabling said ball to be biased to extend into said ball well for releasably retaining said pin in said pin well, said ball well having a bounding surface being concavely arcuate with respect to said front section thereby enabling said bounding surface of said ball well to conform to said ball when said ball is biased into said ball well, said ball being urged to travel downwardly into said lock well when said pin is pulled outwardly from said pin well thereby enabling said pin to be removed from said pin well; and
an annular ring extending through said rear section of said pin wherein said annular ring is configured to enable the user to extend one of their fingers through said annular ring for removing said pin from said pin well.
